(19) United States
(12) Patent Application Publication
(10) Pub. No.: US 2018/0049575 A1
(43) Pub. Date: Feb. 22, 2018

(54) PARCEL BOX FOR DRONE DELIVERY

(71) Applicant: Frank YAMRICK, Dallas, PA (US)

(72) Inventor: Frank YAMRICK, Dallas, PA (US)

(21) Appl. No.: 15/676,946

(22) Filed: Aug. 14, 2017

Related U.S. Application Data
(60) Provisional application No. 62/377,622, filed on Aug. 21, 2016.

(51) Int. Cl. A47G 29/14; A47G 29/28

(52) U.S. Cl. CPC A47G 29/141; B64C 39/024; A47G 29/28

(57) ABSTRACT

A parcel receiving system for receiving a package preferably delivered by a drone to an automated parcel box positioned adjacent an opening in the building. It has an extendable platform adapted to extend out of opening 8 and receive package. A controller communicates with an external device to receive an unlocking code from the delivery company. When a drone carrying the package gets close to the target location, it sends a code to the controller. If the codes match, it extends a platform to receive the package, retracts the platform moving package into a secure holding area, until a user provide the proper authentication to open the secure holding area to take the package. Holding area may be cooled or heated as required to properly hold the package. Parcel receiving system may also communicate with a smartphone to indicate that a package was been received, or provide pictures/video of the package.

### CROSS-REFERENCE TO RELATED APPLICATIONS

This application claims priority to U.S. Provisional Patent Application Ser. No. 62/377,622, filed Aug. 21, 2016, the disclosure of which is hereby incorporated by reference in its entirety to provide continuity of disclosure to the extent such a disclosure is not inconsistent with the disclosure herein.

### FIELD

Aspects of the present invention relate to an automated parcel box adapted to receive a package delivered by a drone, and more specifically for a secure automated parcel box adapted to receive a package delivered by a drone.

### BACKGROUND

There are been increasing number of plans of delivering packages using flying drones. One of the problems encountered is that a drone typically lands in an open area to release the package that is now potentially exposed to theft. The more open the area is for landing, the more noticeable the package will be. One possible way to make the packages less noticeable is to try to fly and land the drone and the package close to the building. However this exposes the drone to potential collisions with the building.

Drones are also susceptible to collisions with small obstructions such as clotheslines, antennas, storage sheds, and other structures in or around the building. Typically, these are not on maps, or in the case of the clothesline, too narrow to be seen easily.

A further problem exists in that in areas which multiple tenants share a single yard or common area. This is the case for tenants in a high-rise building. If the drone lands and delivers a package to the open common area near the high-rise building, and the intended recipient of the package is not present, there is the possibility that another person may steal the package. There is no outdoor location that is specific to any one of the tenants in which to deliver a package.

Currently, there is a need for a system and method of automatically receiving packages at locations which do not have an accessible, secure receiving area.

### BRIEF SUMMARY

According to aspects of the present inventive concepts there is provided an apparatus and method as set forth in the appended claims. Other features of the inventive concepts will be apparent from the dependent claims, and the description which follows.

In one example there is described a parcel receiving system for receiving a package delivered by a delivery company to a target location in a building having an automated parcel box having a portion which can extend out of an opening in the building, a receiving area adapted to receive package, an automated door which opens to allow access to a receiving area, a door actuator coupled to the automatic door, and adapted to open and close automated door when activated. It also includes a controller coupled to the door actuator, the controller adapted to communicate with the delivery company to receive an unlocking code from the delivery company, compare the unlocking code received to one acquired from a delivery vehicle, and actuate the door actuator to open the receiving area when the codes match.

In another example, there is described a parcel receiving system for receiving a package delivered by a delivery company to a target location in a building having an automated parcel box positioned adjacent an opening in the building, an extendable platform adapted to extend out of opening and receive package, a platform actuator coupled to the platform, and is adapted to open and close automated door when activated, an automated door which opens to allow access to a holding area. It also includes a door actuator coupled to the automatic door adapted to open and close automated door when activated. A controller is coupled to the door actuator and is adapted to receive an unlocking code from the delivery company, compare the unlocking code received to one acquired from a delivery vehicle, and actuate the platform actuator to extend the platform when the codes match. Controller is also adapted to actuate the door actuator to open the automated door, actuate the platform actuator to retract the platform moving package into holding area receiving the package.

### BRIEF DESCRIPTION OF SEVERAL VIEWS OF THE DRAWINGS

The advantages of the instant disclosure will become more apparent when read with the specification and the drawings, wherein:

FIG. 1 illustrates an overall block diagram of one embodiment of a parcel receiving system in accordance with the present invention;

FIG. 2 is more detailed perspective view of an automated parcel box of FIG. 1 in accordance with the present invention;

FIG. 3 is a top plan view of the automated parcel box of FIG. 2; and

FIG. 4 is a rear elevational view of the automated parcel box of FIG. 2;

FIG. 5 is a side elevational view of the automated parcel box of FIG. 2;

FIG. 6 is a front elevational view of the automated parcel box of FIG. 2;

FIG. 7 is more detailed perspective view of a second embodiment of the automated parcel box of FIG. 1 in accordance with the present invention;

FIG. 8 is a top plan view of the automated parcel box of FIG. 7; and

FIG. 9 is a side elevational view of the automated parcel box of FIG. 7;

FIG. 10 is a front elevational view of the automated parcel box of FIG. 7;

FIG. 11 is more detailed perspective view of a third embodiment of the automated parcel box of FIG. 1 in accordance with the present invention;

FIG. 12 is a top plan view of the automated parcel box of FIG. 11; and

FIG. 13 is a side elevational view of the automated parcel box of FIG. 11;

FIG. 14 is a front elevational view of the automated parcel box of FIG. 11;

### DETAILED DESCRIPTION

The present invention will now be described in detail by describing various illustrative, non-limiting embodiments thereof with reference to the accompanying drawings. The invention may, however, be embodied in many different forms and should not be construed as being limited to the illustrative embodiments set forth herein. Rather, the embodiments are provided so that this disclosure will be thorough and will fully convey the concept of the invention to those skilled in the art. The claims should be consulted to ascertain the true scope of the invention.

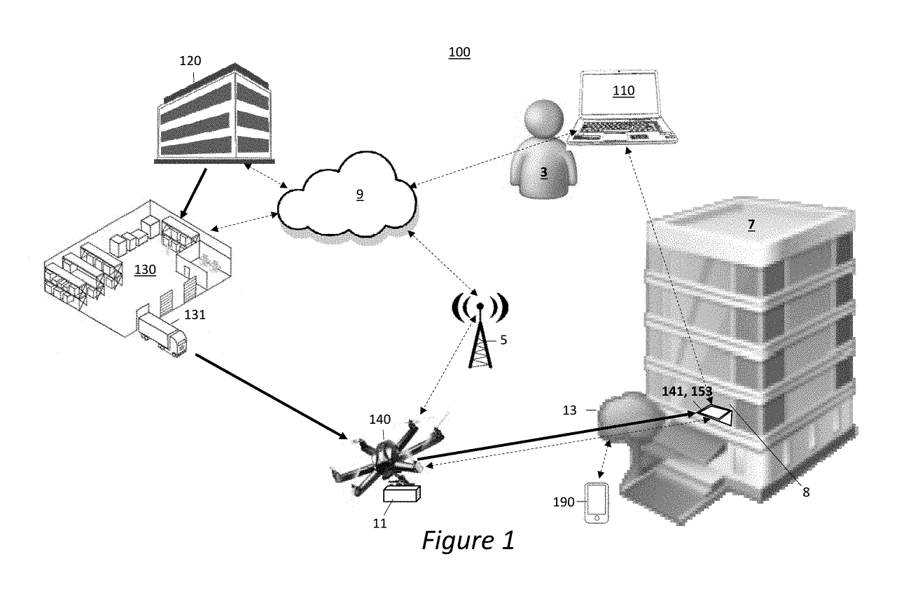

FIG. 1 illustrates an overall block diagram of one embodiment of a parcel receiving system 100 in accordance with the present invention. A customer 3 interacts with computing device 110 to contact an e-commerce site 120 through a network 9 such as the Internet. Customer 3 purchases a product which is to be delivered to a location such as a multilevel building 7. In the case of an apartment in a multilevel building which only has shared space around it and does not have its own secure and private area, it is a problem to deliver packages specifically to this apartment.

With the use of the parcel receiving system 100 described and shown in this application, packages 11 can now be delivered by a drone's 140 directly to the apartment. It is now possible to use the automated parcel box 150 according to the present invention, to receive packages 11 directly into a window or balcony.

Initially, the customer 3 must acquire information as to where to deliver the package. This may be by standard address, floor and position on floor (6th window from the left on the southeast side of the building.

In an alternative embodiment, the customer has a positioning device 120, which may be a GPS device, or a smartphone running an App that determines its current GPS locations. The user takes position device 120 to the target location 141 where the drone is to leave the package 11, which in the embodiment of FIG. 1 is the outside portion 153 of automated parcel box 150. Positioning device 120 determines the GPS location, and height of target location 141. This may receive a different package 11. Information will be transferred to the computing device 110 to be sent to e-commerce system 120.

Positioning device 120 may also have some type of distance detection device, such as ultrasound, or laser ranging that can detect a distance to obstacles, or to determine a correct approach path. In one embodiment of the current invention, the customer 3 identifies the locations of obstacles near the target location 141. For example, customer 3 walks the positioning device 120 to all obstacles within a predetermined radius from the target location 141, such as under tree 13. Once under tree 13, the positioning device 120 is activated to identify the GPS location and measure the height and width of the tree. This information is provided to the e-commerce system 120 when the customer 3 purchases a product from the e-commerce system 120. The e-commerce site 120 passes this information on to a delivery company 130 through Internet 9 or directly to the delivery company 130. The information is used to determine a flight path around obstructions near the target location 141.

In an alternative embodiment, the flight path may be computed by the e-commerce system 120, or computing device 110 and provided to the delivery company 130.

In still another embodiment, the positioning device 190 may downloads information directly to the delivery company 130.

A transaction code and/or digital signature/authorization is generated and shared between the delivery company 130 and the automated parcel box 150.

The delivery company 130 also indicates an intended time of delivery; which is optionally updated during delivery.

Optionally, customer 3 may indicate through computing device 110 that the delivery location is accessible to human delivery (ground level) or it is only accessible by aerial delivery (in the case of apartment window drone receipt box).

Also, optionally, the e-commerce system 120 or delivery company 130 may indicate storage instructions for the package. If may identify if the package 11 must be kept warm or cool, can specify storage instructions, may indicate a spoilage date and other specific instructions.

The delivery may be partially by a vehicle such as a truck 131, then provided to a drone 140 which flies the package to the identified location.

Delivery company 130 monitors the location of package 11 during delivery. Delivery company 130 estimates a time of arrival of the package to the target location. Conventional GPS may be used to track truck 131 and to work, drone 140 to identify the progress of delivery. Drone 140 may radio back its location by using a communication tower 5 such as a cell phone tower, which passes through Internet 92 delivery company 130. The estimated delivery time may then be provided to either computing device 110 which provides information to automated parcel box 150 or and may be passed directly from drone 142 parcel box 150. In an alternative embodiment parcel box 150 a have a direct connection to Internet 9 and communicate directly with delivery company 130. In any case, automated parcel box 150 receives an updated estimated time of arrival of the package 11.

Automated parcel box 150 creates a time window around the estimated time of arrival. It then on a response to a delivery code received during this time window. The delivery code may be sent wirelessly by drone 140 as it approaches automated parcel box 150. The unlocking code may also be sent by delivery company 130 through Internet 9 and to automated parcel box 150.

Once the proper unlocking code is received by automated parcel box 150 either wirelessly or through a network, it is activated prepares to receive the package 11.

In another alternative embodiment, there is no lock, allowing one to receive the package without requiring an unlocking code.

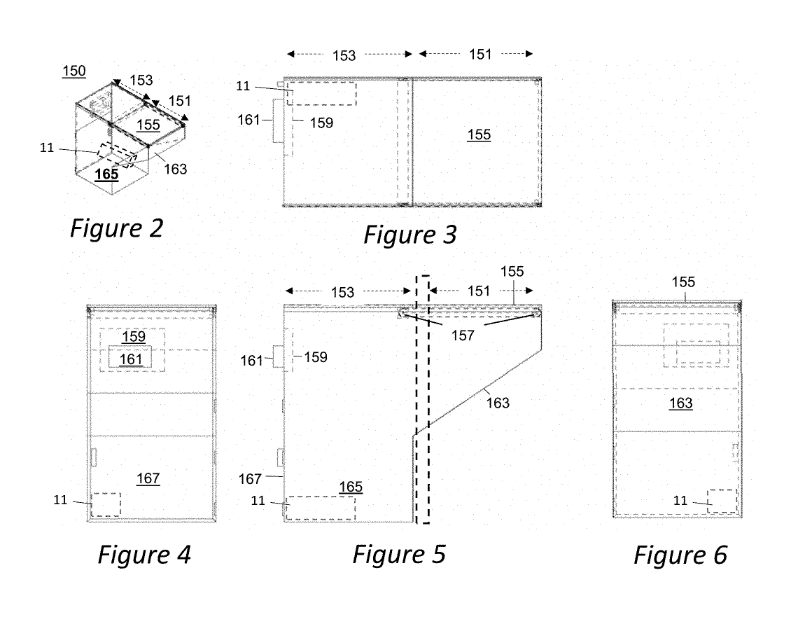

FIG. 2 is more detailed perspective view of an automated parcel box 150 of FIG. 1 in accordance with the present invention. Automated parcel box 150 has an outside portion 151 which extends out of a window or balcony far enough for a drone to land on it or drop the package inside it. It also has an inside portion 153 which is located in the side the building 7.

The automated parcel box 150 also includes a controller 159 that allows interaction with network, as well interaction with other devices in local proximity via Wi-Fi communications or other known communications system.

Automated parcel box 150 receives an estimated time of arrival of the package from either the drone 140, the delivery company 130, the e-commerce site 120, or the computing device 110.

As it gets close to the estimated time of arrival, controller 159 listen for the delivery code. This delivery code may be transmitted to it wirelessly, or in an optional embodiment may be provided through the Internet 9. As indicated above, the delivery code is only accepted if it is received within the time window around the estimated time of arrival. This is the security measure in which it is made to ignore even the proper code that is provided at the wrong time.

Once controller 159 receives the proper delivery code it activates an actuator 157 which opens automated door 155.

The drone is now allowed to hover above the outside portion 151 of parcel box 150 that is now open. The drone 140 is now allowed to drop package 11 into the outside portion 151 of parcel box 150.

The package 11 gently slides down angled slide 163 and into a holding area 165. An operator can then provide a code to unlock and open and access door 167 and remove package 11 from holding area 165.

FIG. 3 is a top plan view of the automated parcel box 150 of FIG. 2. Here the inside portion 153 and the outside portion 151 can easily be seen. Controller 159 is shown in phantom and operating panel 161 is visible to the left. In this configuration automatic door 155 is shown in its closed position.

FIG. 4 is a rear elevational view of the automated parcel box 150 of FIG. 2. This view shows operators panel 161 and access door 167 clearly.

FIG. 5 is a side elevational view of the automated parcel box of FIG. 2. In this view the operators panel 161 is visible log with the controller 159 in phantom the holding area 165 is visible at the bottom of angled slide 163 to the right automated door 155 is shown in its closed position and actuators 157 are also shown.

FIG. 6 is a front elevational view of the automated parcel box of FIG. 2. This is a view from outside of the building 7.

Optionally, the parcel receiving system 100 employs a scanner 171 to read any labels on package 11. The scanner 171 is preferably located in the holding area 165 and can read bar codes, QR codes, optical code patterns, RFID tags, or text. This information is provided to the controller 159 which may display it on operating panel to indicate the package 11 being held.

Also optionally, the holding area 165 of the parcel receiving system 100 employs a label printer 173 which can print the intended recipient's name, address or other identifying information on the package 11.

There may also be a temperature regulation device 175 in the holding area 165 to keep the package a specified temperature or make sure that it does not exceed a maximum or minimum temperature indicated by the e-commerce system or the delivery company.

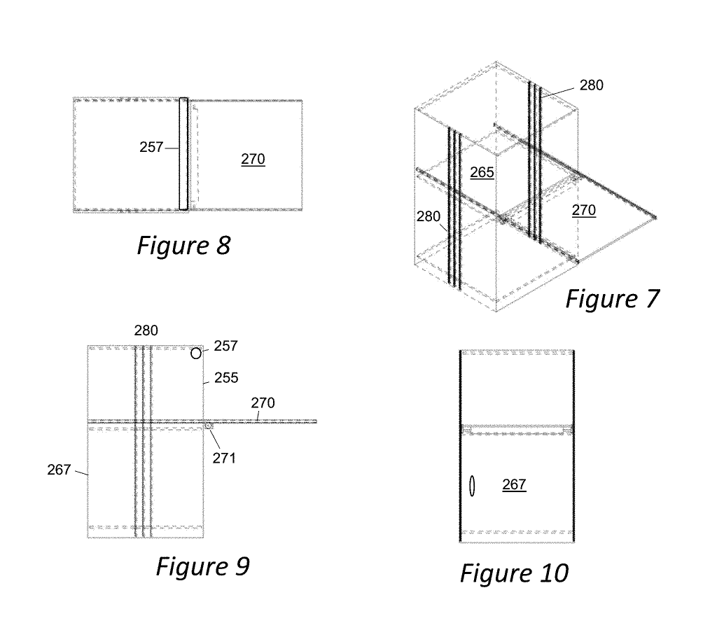

FIG. 7 is more detailed perspective view of a second embodiment of the automated parcel box 250 of FIG. 1 in accordance with the present invention. Automated parcel box 250 is positioned inside of the building 7 adjacent an opening 8 in building 7 such as a window or balcony.

Automated parcel box 250 has at least one extendable and retractable platform 270 that is shaped and sized to be able to extend out of opening 8 and receive a package 11. The platform actuator 271 is coupled to controller 259 and extends or retracts under the control of controller 259.

Controller 259 also has the capability to communicate with through a network 9, as well interact with other devices in local proximity. It may is any commonly known wired or wireless communications system.

Automated parcel box 250 receives an estimated time of arrival of the package 11 from either the delivery vehicle 131, a drone 140, the delivery company 130, the e-commerce site 120, or the computing device 110.

As it gets close to the estimated time of arrival, controller 259 listen for the delivery code. This delivery code may be transmitted to it wirelessly, or in an optional embodiment may be provided through the Internet 9. As indicated above, the delivery code is only accepted if it is received within the time window around the estimated time of arrival. This is the security measure in which it is made to ignore even the proper code that is provided at the wrong time.

Once controller 259 receives the proper delivery code it activates an actuator 257 which extends platform 270.

The drone 140 is now allowed to hover above the platform 270. The drone 140 is now allowed to drop package 11 onto platform 270 of parcel box 250.

In a preferred embodiment, controller 259 identifies the height package 11 by reading a height sensor 281. Height sensor 281 may be any conventional sensor which is capable of measuring the height of package 11. It may be a mechanical sensor, an optical sensor, or other known sensor.

Now that controller 259 knows the height of package 11, it can activate door actuator 257 to open automated door 255 to at least a height which would allow package 11 to enter a holding area 265 within automated parcel box 250. Controller 259 accomplishes this my activating a platform actuator 271.

If holding area 265 does not have enough room available to receive packages 11, controller 259 does not activate platform actuator 271 because this would cause package 11 to be inadvertently pushed off of platform 270, and fall to the ground, possibly destroying package 11.

Automated parcel box 250 may also include more than one platform 270 and platform actuator 271. In this embodiment, the automated parcel box 250 can now receive multiple packages 11 and store each in a different portion of holding area 265.

In still another embodiment, the spacing between multiple platforms 270 can be adjusted to hold packages of different heights. A plurality of shelving positioners 280 attached to each platform assembly and can move each vertically to increase or decrease the spacing between it and platforms above and below it. The shelving positioners are shown here to be gears which run up and down a toothed track, however, they can be any conventional mechanical systems known to do this purpose.

An operator can then provide a code to unlock and open and access door 167 and remove package 11 from holding area 165.

FIG. 8 is a top plan view of the automated parcel box of FIG. 7. Here the platform 270 is fully extended outside of the building 7 while the reminder of the automated parcel box 250 is within the building.

Controller 259 and operating panel 161 are shown in phantom and are visible to the left.

FIG. 9 is a side elevational view of the automated parcel box of FIG. 7. In this view the operating panel 161 and the controller 159 are shown in phantom to the left.

Platform 270 slides on rails 273 to retract and extend. The door actuators 257, are visible at the top right. The shelving positioners 280 are shown which extend vertically.

FIG. 10 is a rear elevational view of the automated parcel box of FIG. 7. This view shows access door 267 clearly. In this embodiment, there is only a single access door 267. In alternative embodiments may be more than one access door each having some means of locking and unlocking the door to allow access to the package 11. This may be done by providing a proper code to the operating panel 261 in which controller 259 reads and validates the code, and if correct, allows access door 267 to be opened.

In this manner, automated parcel box 250 may be able to act as a secure parcel mailbox for a number of different entities.

Each of the embodiment described above may include an automated window actuator 177 employing conventional mechanical systems, that is operated by the controller to open window 8 before receiving the package 11 and close window 8 after receiving the package 11. This would allow the window to remain closed until just before delivery and close again after delivery.

Optionally, there may be one or more cameras 181 to provide images of the contents of holding area 165 on the operating panel 161, or other viewing device.

The camera may also be useful to view the receiving area and the as a package 11 is being received.

Controller 159 may also include the capability to send an email notification to the customer 3 indicating when the package was received and also indicating any of the other information it has on the package 11 such as expiration date and the name of the delivery company and e-commerce system.

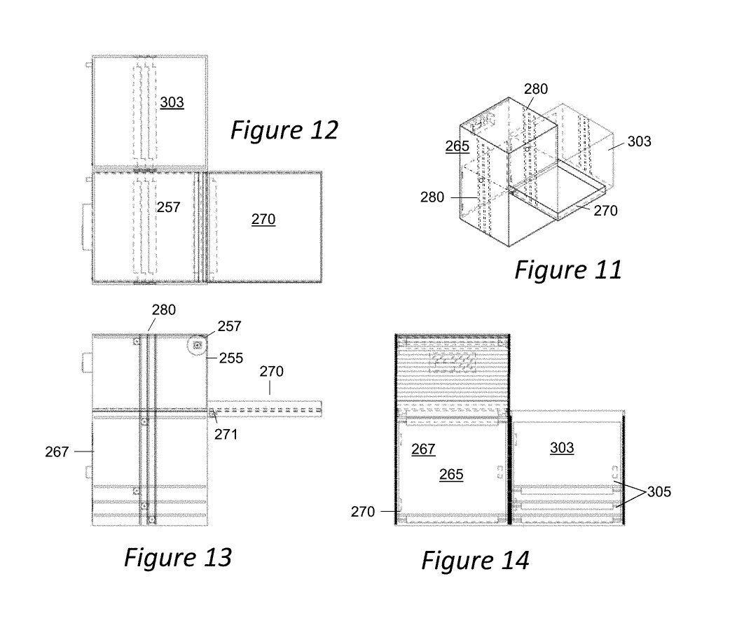

FIG. 11 is more detailed perspective view of a third embodiment of the automated parcel box of FIG. 1 in accordance with the present invention. This functions in the same manner and automated parcel box 250, with the exception of the additional storage unit 303.

Additional storage unit 303 may include any or all of the equipment and mechanisms described above for the other storage areas. After a package is deposited on the platform 270, platform actuator 271, driven by controller 259 retracts the platform from outside of the building to inside of holding area 265. The platform may then be moved up or down by shelving positioners 280. In this embodiment, an actuator (not shown) which may be any conventionally known actuator can push package 11 off of platform 270 and onto a shelf within storage unit 303. This shelf may then be moved up or down to maximize space by controller 259.

In an alternative embodiment, each compartment is locked. Access can only be provided individually to a given compartment when a proper authorization is provided to controller 259 for that compartment. This may be information on a magnetic strip, bar code, QR code, biometric or other conventional authentication means. In this embodiment, it may be a secure parcel mailbox for a number of different users.

FIG. 12 is a top plan view of the automated parcel box of FIG. 11. This shows the additional storage compartment 303.

FIG. 13 is a side elevational view of the automated parcel box of FIG. 11. This is similar to FIG. 9 and shows similar structures.

FIG. 14 is a rear elevational view of the automated parcel box of FIG. 11. A package 11 that is received onto platform 270 in holding area 265 (behind door 267) can be elevated to be the same height as top shelf 305. The package can then be pushed to the right onto shelve 305 in storage unit 303 for storage. Shelf 305 may then be raised or lowered to maximize the number of packages that may be stored in storage unit 303.

Since other modifications and changes varied to fit particular operating requirements and environments will be apparent to those skilled in the art, the invention is not considered limited to the example chosen for the purposes of disclosure, and covers all changes and modifications which do not constitute departures from the true spirit and scope of this invention.

What is claimed is:

1. A parcel receiving system for receiving a package delivered by a delivery company to a target location in a building comprising:
a. an automated parcel box having a portion which can extend out of an opening in the building;
b. a receiving area adapted to receive package;
c. an automated door which opens to allow access to a receiving area;
d. a door actuator coupled to the automated door, and is adapted to open and close automated door when activated;
e. a controller coupled to the door actuator, the controller adapted to communicate with the delivery company to receive an unlocking code from the delivery company, compare the unlocking code received to one acquired from a delivery vehicle, and actuate the door actuator to open the receiving area when the codes match.

2. The parcel receiving system of claim 1, wherein the delivery company also sends an estimated time of arrival (TOA), and the controller only accepts valid unlocking codes within a predetermined time window around the TOA.

3. The parcel receiving system of claim 1, wherein the opening in the building is one of the group consisting of: a window, door, balcony, and a portal.

4. The parcel receiving system of claim 1, wherein the target location is above the first floor and the delivery vehicle is a drone.

5. The parcel receiving system of claim 1, further comprising:
a. a locking, internal holding area for securely retaining the package;
b. an angled slide extending between the receiving area to the holding area allowing the package to gently slide from the receiving area to the holding area.

6. The parcel receiving system of claim 1, further comprising:
a temperature regulation device for keeping the holding area a different temperature from the ambient temperature.

7. The parcel receiving system of claim 1, further comprising:
a camera for monitoring in an around the parcel receiving system.

8. The parcel receiving system of claim 1, further comprising:
a notification system to provide a notification when a package is arriving.

9. The parcel receiving system of claim 8, wherein the notification system can send to a smart phone one of: text messages, video messages, audio messages, graphics.

10. The parcel receiving system of claim 1, further comprising:
a positioning device adapted to determine a location of the target location.

11. The parcel receiving system of claim 1, wherein the positioning device is adapted to determine a GPS location and height of the target location.

12. The parcel receiving system of claim 4, wherein the positioning device adapted to determine a GPS location and height of an obstacle in a predetermined distance from the target location.

13. A parcel receiving system for receiving a package delivered by a delivery company to a target location in a building comprising:
a. an automated parcel box positioned adjacent an opening in the building;
b. an extendable platform within the automated parcel box adapted to extend out of opening 8 and receive package;
c. a platform actuator coupled to the extendable platform adapted to open and close automated door when activated;
d. an automated door which opens to allow access to a holding area;
e. a door actuator coupled to the automatic door, and is adapted to open and close automated door 255 when activated;
f. a controller coupled to the door actuator, the controller adapted to:
i. receive an unlocking code from the delivery company,
ii. compare the unlocking code received to one acquired from a delivery vehicle, and
iii. actuate the platform actuator to extend the extendable platform when the codes match; and
iv. actuate the door actuator to open the automated door;
v. actuate the platform actuator to retract the platform after the package has been received, moving package into holding area.

14. The parcel receiving system of claim 13, further comprising:
a. a sensor capable of measuring height of the package on platform; and
b. controller is further adapted to determine if package will fit into holding area; and restricts door actuator platform actuator from operating if the package is too large to fit into holding area.

15. The parcel receiving system of claim 14, wherein the controller is further adapted to:
activate door actuator to open automated door to a height greater than the measured height of package.

16. The parcel receiving system of claim 15, further comprising:
a. a plurality of platforms each actuated by a platform actuator to extend and retract the platforms;
b. a plurality of shelving positioners each connected to a platform capable of moving each of the platforms in a vertical direction;
c. wherein the controller is further adapted to:
adjust a vertical position of each platform to maximize the number of packages 11 that can be stored in the holding area.

17. The parcel receiving system of claim 15, further comprising:
a. an auxiliary containment unit having:
i. a plurality of platforms each actuated by a platform actuator to extend and retract the platforms;
ii. a plurality of shelving positioners each connected to a platform capable of moving each of the platforms in a vertical direction;
b. wherein the controller is further adapted to:
adjust a vertical position of each platform to maximize the number of packages that can be stored in the holding area.

18. A method of securely delivering a package to a building comprising the steps of:
a. providing an automated parcel box having a receiving area capable of extending out of the building;
b. communicating from the delivery vehicle to the automated parcel box an estimated delivery time;
c. receiving from the delivery vehicle a code to ready the automated parcel box to receive the package;
d. comparing the received code to a presorted code and readying the parcel box to receive the package if they match;
e. receiving the package at the receiving area;
f. moving the package from the receiving area to a secure holding area; and
g. opening the holding area upon the user providing the proper authentication.

19. The method of claim 18 wherein readying the automated parcel box comprises the step of:
extending a platform out of building.

20. The method of claim 19 wherein moving the package comprises the step of:
retracting the platform into the holding area.

21. The method of claim 18 wherein the automated parcel box employs a plurality of platforms, and each which may receive and retract a package into a different portion of the holding area.

22. The method of claim 21 further comprising the step of:
adjusting a vertical spacing between the platforms to maximize the number of packages stored within holding area.
